(19) United States
(12) Patent Application Publication
(10) Pub. No.: US 2004/0128622 A1
(43) Pub. Date: Jul. 1, 2004

(54) Method and server for communicating information between publishers and subscribers of web services

(76) Inventors: Highland Mary Mountain, Gilbert, AZ (US); Jackson He, San Diego, CA (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/329,625

(22) Filed: Dec. 26, 2002

(51) Int. Cl. G06F 15/00

(52) U.S. Cl. 715/530

(57) ABSTRACT

A method and a server for communicating information between subscribers and publishers of web services are described herein. The server may register with a web services registry to provide binding information in accordance with a web services standard-based protocol via the Internet. Based on the binding information, the server may receive publication information associated with a publisher, and subscription information associated with a subscriber. The subscription information may include a subscription event selected by the subscriber based on the publication information. Accordingly, the server may transmit a notification message to the subscriber in response detecting the subscription event within the server.

### TECHNICAL FIELD

The present disclosure relates to web services, and more particularly, to a method and a server for communicating information between publishers and subscribers of web services.

### BACKGROUND

Publish-subscribe systems are used to disseminate information to a large number of people. A provider of web services (i.e., a software application identified by a uniform resource identifier (URI)) may provide information to consumers (i.e., subscribers) via the Internet. For example, web services or application services may be storage management, customer relationship management, or services that provide stock quote or bids for an auction item. However, subscribers may be required to use vendor-specific proprietary protocols (e.g., middleware) and/or additional add-ons such as plug-ins, software configurations, or hardware for system integration. In particular, middleware and/or additional add-ons may mediate the exchange of procedures and/or data between two separate software applications. For example, a program running in one kind of operating system (e.g., Windows) may need middleware and/or add-ons to communicate with a program running in another kind of operating system (e.g., (UNIX)). Thus, it is costly to integrate applications running in different operating systems. Further, most publish-subscribe systems (e.g., a bulletin board) are implemented via an intranet, i.e., a private network that is contained within an enterprise such as a corporation, a small business, a government body, or other kinds of organizations. As the use of web services increases, there is a need for application-to-application communication and interoperability in a vendor-independent environment via the Internet.

### BRIEF DESCRIPTION OF THE DRAWINGS

This disclosure will describe several embodiments to illustrate its broad teachings. Reference is also made to the attached drawings.

FIG. 1 is a block diagram representation of a communication system.

FIG. 2 is an information flow diagram representation of the communication system.

FIG. 3 is a block diagram representation of a server.

FIG. 4 is a flow diagram illustrating a method for communicating information between publishers and subscribers of web services.

### DETAILED DESCRIPTION

A method and a server for communicating information between publishers and subscribers of web services are described herein. A server may be registered with a web services registry to provide binding information for publishers and subscribers to communicate with each other in accordance with a web services standard-based protocol via the Internet. As used herein “Internet” refers to a worldwide system of computer networks (i.e., a network of networks). For example, the server may be registered with a universal description, discovery, and integration (UDDI) node, which serves as a yellow-page-like directory for publishers and subscribers. In particular, the web services registry may provide a uniform resource identifier (URI) such as a uniform resource locator (URL), i.e., a domain name, so that publishers and subscribers may find the server on the Internet. The web services standard-based protocol may be, but is not limited to, a simple object access protocol (SOAP), a web services description language (WSDL) based protocol, an extensible markup language (XML) based protocol, a hypertext transfer protocol (HTTP), and an universal description, discovery and integration (UDDI) based protocol. Using the web services standard-based protocol, publishers and subscribers who use programs running in different operating systems (e.g., Windows, DOS, UNIX, Linux, Palm OS, Mac OS, and OS/400) may communicate with each other via the server.

To illustrate this concept, publishers and subscribers may communicate directly and register with the server based on the binding information. In particular, the server may receive publication information associated with a publisher such as, but not limited to, a publisher identifier, a publication event, and cache data associated with the publication event. Subscribers may select a number of publishers and publication events registered with the server. Accordingly, the server may receive subscription information associated with a subscriber such as, but not limited to, a subscriber identifier, and a subscription event. The subscription event may be information of interest to the subscriber. To keep track of all registered publishers and subscribers, the server may store publication information and subscription information associated with registered publishers and subscribers within a database.

In response to detecting the subscription event, the server may transmit a notification message to the subscribers who selected the subscription event. For example, the publisher may be an employee of a company and the subscriber may be the human resource (HR) department of the company. When the employee distributes a new home address, the HR department may receive a notification message from the server indicating that the employee has a change of home address. Further, the HR department may receive cache data from the server (e.g., the new home address of the employee) to update its records. The server may automatically receive the new home address from the employee or download that information from the application operated by the employee. To implement a one-to-many application, the server may also transmit the notification message to other subscribers such as the payroll department of the company. As a result, the server may allow the publisher (e.g., the employee) and the subscriber (e.g., the HR department and/or the payroll department) to communicate with each other without vendor-specific middleware and/or special plug-ins when they are using programs that run in different operating systems.

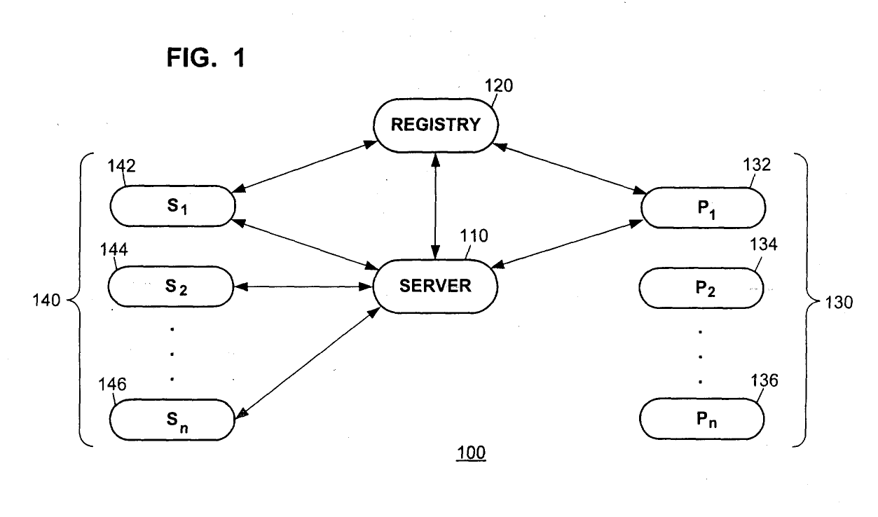

Referring to FIG. 1, a communication system 100 such as a publish-subscribe (pub-sub) system for web services generally includes a web services pub-sub server 110, a web services registry 120, a plurality of publishers 130, generally shown as P₁ 132, P₂ 134, and Pₘ 136, and a plurality of subscribers 140, generally shown as S₁ 142, S₂ 144, and Sₙ 146. As used herein “web services” refer to services that are made available by an enterprise such as, but not limited to, a corporation, a small business, a government body, or other kinds of organizations for system users or other programs. For example, web services may include, but are not limited to, storage management, customer relationship management, or services that provide stock quote or bids for an auction item.

The web services pub-sub server 110 is operatively coupled to the web services registry 120, the plurality of publishers 130 and the plurality of subscribers 140. Because the plurality of publishers 130 and the plurality of subscribers 140 may operate programs running in different operating systems, the web services pub-sub server 110 may operate in accordance with a web services standard-based protocol so that the plurality of publishers 130 and the plurality of subscribers 140 may communicate with each other without using any vendor-specific middleware and/or special plug-ins. The web services standard-based protocol may be, but is not limited to, a simple object access protocol (SOAP), a web services description language (WSDL) based protocol, an extensible markup language (XML) based protocol, a hypertext transfer protocol (HTTP), and an universal description, discovery and integration (UDDI) based protocol. As used herein an “operating system” refers to a program that manages all other programs in a computer (i.e., applications, which are programs designed to perform specific functions). Some examples of an operating system include, but are not limited to, Disk Operating System (DOS), Windows NT, Windows 2000, Windows ME, Mac OS, UNIX, Linux, Palm OS, Multiple Virtual Storage (MVS), OS/390, and OS/400.

The web services registry 120 such as, but not limited to, an universal description, discovery, and integration (UDDI) node, may serve as a directory of web services so that others may discover the web services pub-sub server 110. In particular, each of the plurality of publishers 130 and the plurality of subscribers 140 may discover the web services pub-sub server 110 via the web services registry 120. The plurality of publishers 130 and the plurality of subscribers 140 may provide publication information and subscription information, respectively, to the web services pub-sub server 110.

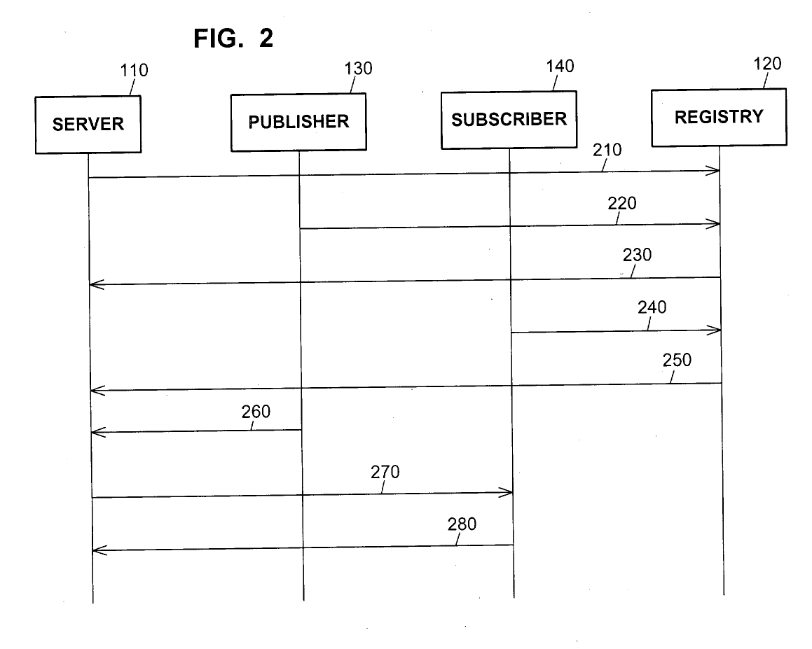

Referring to FIG. 2, a basic flow for communicating information between publishers and subscribers may start with establishing and registering the web services pub-sub server 110 at the web services registry 120. In particular, the web services pub-sub server 1 10 may provide binding information 210 to the web services registry 120 so that publishers 130 and subscribers 140 may determine how to bind with the web services pub-sub server 110. For example, the web services pub-sub server 110 may provide a uniform resource identifier (URI) such as a uniform resource locator (URL), i.e., a domain name, to the web services registry 120. Accordingly, publishers 130 and subscribers 140 may find the web services pub-sub server 110 at the UDDI node 120 and determine how to communicate with the web services pub-sub server 110 directly. If the domain name of the web services pub-sub server 110 changes, for example, the plurality of publishers 130 and the plurality of subscribers 140 may communicate with the UDDI node 120 to find the new domain name of the web services pub-sub server 110.

Upon finding the web services pub-sub server 110, each of the plurality of publishers 130 may register 230 with web services pub-sub server 110 and provide information for distribution. Each of the plurality of publishers 130 may provide information without knowing which subscribers and/or applications are interested. Also, the plurality of publishers 130 may not be operable to communicate directly with the plurality of subscribers 140 because the plurality of publishers 130 and the plurality of subscribers 140 may be using programs running in different operating systems. Thus, instead of communicating directly with the plurality of subscribers 140, each of the plurality of publishers 130 may transmit information to the web-services pub-sub server 110, which in turn, may distribute that information to the plurality of subscribers 140.

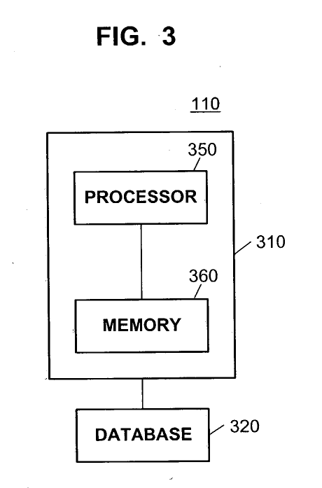

Each of the plurality of subscribers 140 may query for binding information 240 associated with the web services pub-sub server 110 on the UDDI node 120, and select a publication event associated with one of the plurality of publishers 130. For example, Subscriber S₂ 144 may subscribe to a newsletter published by Publisher P₁ 132. The web services pub-sub server 110 may keep track of registrations 230 of the plurality of publishers 130 and subscriptions 250 of the plurality of subscribers 140 within a database (one shown as 320 in FIG. 3 and described in detail below).

In another example, one of the plurality of publishers 130 may be an employee of a company, and the employee may wish to change his home address upon moving to a new home. The human resources (HR) department and the payroll department of the company may wish to subscribe to that information. That is, the publication event may be a change of home address by all employees of the company. Rather than providing each of the departments with the new address, the employee may publish the information with the web services pub-sub server 110 so that subscribers such as the HR and the payroll departments may retrieve that information from the web services pub-sub server 110.

When a publication event occurs, for example, the publisher P₁ 132 may asynchronously transmit a notification message 260 to the web service pub-sub server 110. That is, the publisher P₁ 132 may send the notification message to the web service pub-sub server 110 and continue processing without waiting for a response from the web service pub-sub server 110. Further, the publisher P₁ 132 may also transmit data corresponding to the publication event. The data may be cached (i.e., stored) at the web services pub-sub server 110 so that subscribers 140 may retrieve the data. The web services pub-sub server 110 may operate as a repository for the publisher P₁ 132. Alternatively, the web services pub-sub server 110 may download the data from the publisher P₁ 132 after receiving the notification message.

In response to the notification message from the publisher P₁ 132, the web services pub-sub server 110 may forward the notification message 270 to the plurality of subscribers 140 based on subscription information stored in the database (one shown as 320 in FIG. 3). For example, the web service pub-sub server 110 may transmit the notification message to Subscriber S₁ 142 if Subscriber S₁ 142 subscribed to the publication event detected by the web service pub-sub server 110.

Upon receiving the notification message from the web services pub-sub server 110, the subscriber (e.g., Subscriber S₁ 132) may request 280 for the data cached at the web services pub-sub server 110, i.e., the data corresponding to the publication event. The web services pub-sub server 110 may convert or translate the data to a format requested by the subscriber.

Referring to FIG. 3, a web services pub-sub server 110 adapted to communicate information between publishers and subscribers of web services is shown. The web services pub-sub server 110 generally includes a controller 310 and a database 320. The controller 310 includes a processor 350 and a memory 360. The processor 350 is operatively coupled to the memory 360, which stores a program or a set of operating instructions for the processor 350. The controller 310 executes the program or the set of operating instructions such that the web services pub-sub server 110 operates as described herein. The program of the set of operating instructions may be embodied in a computer-readable medium such as, but not limited to, paper, a programmable gate array, an application specific integrated circuit (ASIC), an erasable programmable read only memory (EPROM), a read only memory (ROM), a random access memory (RAM), a magnetic media, and an optical media. The controller 310 may operate in accordance with a web services standard-based protocol such as a simple object access protocol (SOAP), a web services description language (WSDL) based protocol, an extensible markup language (XML) based protocol, a hypertext transfer protocol (HTTP), and an universal description, discovery and integration (UDDI) based protocol. By operating in accordance with the web services standard-based protocol, the web services pub-sub server 110 may allow publishers and subscribers who are using programs that run in different operating systems to communicate with each other. For example, a publisher using a program running in Windows may communicate with a subscriber using a program running in UNIX via the web services pub-sub server 110. The controller 310 and the database 320 may be configured as multiple components as shown FIG. 3 or be configured as a single (e.g., integral or unitary) component within the server 110. In particular, the database 320 may be used to store publication information from publishers, and subscription information from subscribers.

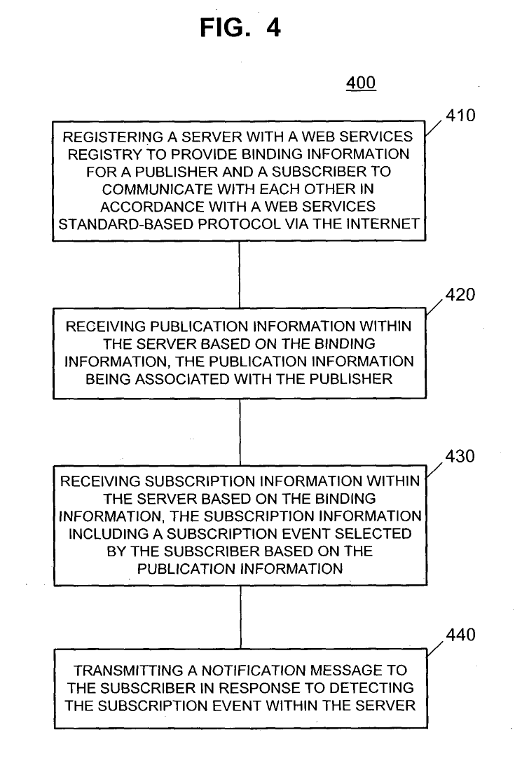

One possible implementation of the computer program executed by the web services pub-sub server (e.g., via the controller 310) is illustrated in FIG. 3. Persons of ordinary skill in the art will appreciate that the computer program can be implemented in any of many different ways utilizing any of many different programming codes stored on any of many computer-readable mediums such as a volatile or nonvolatile memory or other mass storage device (e.g., a floppy disk, a compact disc (CD), and a digital versatile disc (DVD)). Thus, although a particular order of steps is illustrated in FIG. 4, persons of ordinary skill in the art will appreciate that these steps can be performed in other temporal sequences. Again, the flow chart 400 is merely provided as an example of one way to program the server to communicate information between operating protocols for web services. The flow chart 400 begins at step 410, wherein the server may register itself with a web services registry such as, but not limited to, an UDDI node. In particular, the server may provide the web services registry with binding information so that publishers and subscribers may be informed on how to bind with the server for web services via the Internet. For example, the server may operate in accordance with a web services standard-based protocol such as, but not limited to, a simple object access protocol (SOAP), a web services description language (WSDL) based protocol, an extensible markup language (XML) based protocol, a hypertext transfer protocol (HTTP), and an universal description, discovery and integration (UDDI) based protocol. Thus, the server may provide the web-services standard-based protocol for communication among publishers and subscribers who are using programs that run in different operating systems. At step 420, the server may receive publishing information from a publisher based on the binding information from the web services registry. For example, the publisher may find the server via the web services registry and provide information associated with the publisher such as, but not limited to, a publisher identifier, a publishing event, and cache data corresponding to the publishing event to the server. The publishing event may be, but is not limited to, a change in data and a new posting of information.

Subscribers may also find the server via the web services registry. Accordingly, a subscriber may query the server for available publishers (i.e., publishers registered with the server), select at least one of the available publishers, and subscribe to at least one publication event offered by one the available publishers. By selecting a publisher and a publication event, the subscriber may receive information from that particular publisher. For example, the subscriber may subscribe to receive a newsletter disseminated by that particular publisher. In another example, the subscriber may enlist to receive a change data associated with the publisher. As a result, the server at step 430 may receive subscription information corresponding to the selection of a publisher and a publication event by a subscriber. The subscription information may include, but is not limited to, a subscriber identifier and a subscription event. That is, the subscription event may correspond to a publisher and a publication event.

In response to detecting the subscription event, the server at step 440 may transmit a notification message to the subscriber. For example, the publisher may notify the server of a change of data associated with the publisher (i.e., the publication event). If the subscriber enlisted to receive a change of data associated with the publisher, the server may transmit a notification message to the subscriber. As a result, the server may allow the publisher and the subscriber to communicate with each other without vendor-specific middleware and/or special plug-ins when they are using programs that run in different operating systems.

Although the method and the server disclosed herein are particularly well suited for use with programs running in different operating systems, persons of ordinary skill in the art will readily appreciate that the teachings herein are in no way limited to such programs. On the contrary, persons of ordinary skill in the art will readily appreciate that the teachings of this disclosure can be employed with programs running in different versions of an operating system or programs that simply cannot communicate with one another (e.g., different data structures, different programming environments, etc.).

Many changes and modifications to the embodiments described herein could be made. The scope of some changes is discussed above. The scope of others will become apparent from the appended claims.

What is claimed is:

1. A method for communicating information between publishers and subscribers of web services, the method comprising:
registering a server with a web services registry to provide binding information for a publisher and a subscriber to communicate with each other in accordance with a web services standard-based protocol via the Internet;
receiving publication information within the server based on the binding information, the publication information being associated with the publisher;
receiving subscription information within the server based on the binding information, the subscription information including a subscription event selected by the subscriber based on the publication information; and
transmitting a notification message to the subscriber in response to detecting the subscription event within the server.

2. The method of claim 1, wherein registering a server with a web services registry to provide binding information via the Internet in accordance with a web services standard-based protocol comprises registering a server with an universal description, discovery, and integration (UDDI) node.

3. The method of claim 1, wherein registering a server with a web services registry to provide binding information in accordance with a web services standard-based protocol via the Internet comprises registering a server with a web services registry to provide binding information in accordance with one of a simple object access protocol (SOAP), a web services description language (WSDL) based protocol, an extensible markup language (XML) based protocol, a hypertext transfer protocol (HTTP), and an universal description, discovery and integration (UDDI) based protocol.

4. The method of claim 1, wherein receiving publication information associated with a publisher within the server based on the binding information comprises receiving one of a publisher identifier, a publication event, and data associated the publication event within the server based on the binding information.

5. The method of claim 1, wherein transmitting a notification message to the subscriber based on the subscription information in response to a trigger event associated with the publisher comprises transmitting a notification message to the subscriber based on the subscription information in response to one of changed data, and new data by the publisher.

6. The method of claim 1 further comprising:
receiving cache data from the publisher within the server, the cache data being associated with the subscription event; and
translating the cache data within the server to transmit to the subscriber.

7. The method of claim 1, wherein the server is operable in accordance with one of a simple object access protocol (SOAP), a web services description language (WSDL) based protocol, an extensible markup language (XML) based protocol, a hypertext transfer protocol (HTTP), and an universal description, discovery and integration (UDDI) based protocol.

8. In a communication system, a server for communicating information between operating protocols for web services, the server comprising:
a memory; and
a processor operatively coupled to the memory, the processor being programmed to register with an web services registry to provide binding information for a publisher and a subscriber to communication with each other in accordance with a web services standard-based protocol via the Internet,
the processor being programmed to receive publication information based on the binding information, the publication information being associated with the publisher,
the processor being programmed to receive subscription information based on the binding information, the subscription information including a subscription event selected by the subscriber based on the publication information, and
the processor being programmed to transmit a notification message to the subscriber in response to detecting the subscription event within the server.

9. The server of claim 8, wherein the web services registry is an universal description, discovery, and integration (UDDI) node.

10. The server of claim 8 is operable in accordance with one of a simple object access protocol (SOAP), a web services description language (WSDL) based protocol, an extensible markup language (XML) based protocol, a hypertext transfer protocol (HTTP), and an universal description, discovery and integration (UDDI) based protocol.

11. The server of claim 8, wherein the publication information includes one of a publisher identifier, a publisher event, and data associated with the publisher event.

12. The server of claim 8, wherein the subscription event is one of a change in information and a new posting of information by the publisher.

13. In a communication system, wherein a server operates in accordance with a computer program embodied on a computer-readable medium for communicating information between publishers and subscribers for web services, the computer program comprising:
a first routine that directs the server to register with an web services registry to provide binding information for a publisher and a subscriber to communication with each other in accordance with a web services standard-based protocol via the Internet;
a second routine that directs the server to receive publication information based on the binding information, the publication information being associated with the publisher;
a third routine that directs the server to receive subscription information based on the binding information, the subscription information including a subscription event selected by the subscriber based on the publication information; and
a fourth routine that directs the server to transmit a notification message to the subscriber in response to detecting the subscription event within the server.

14. The computer program of claim 13, wherein the first routine comprises a routine that directs the server to register with an universal description, discovery, and integration (UDDI) node to provide binding information in accordance with a web services standard-based protocol via the Internet.

15. The computer program of claim 13, wherein the first routine comprises a routine that directs the server to register with a web services registry to provide binding information in accordance with one of a simple object access protocol (SOAP), a web services description language (WSDL) based protocol, an extensible markup language (XML) based protocol, a hypertext transfer protocol (HTTP), and an universal description, discovery and integration (UDDI) based protocol via the Internet.

16. The computer program of claim 13, wherein the first routine comprises a routine that directs the server to transmit a notification message to the subscriber in response to a change in data and a posting of information by the publisher.

17. The computer program of claim 13 further comprising:
a routine that directs the server to receive cache data from the publisher, the cache data being associated with the subscription event; and
a routine that directs the server to translate the cache data to transmit to the subscriber.

18 The computer program of claim 13, wherein the medium is one of paper, a programmable gate array, application specific integrated circuit, erasable programmable read only memory, read only memory, random access memory, magnetic media, and optical media.

19. A method for integrating legacy applications and systems, the method comprising:
providing a server configured to communicate with legacy applications in accordance with a web services standard-based protocol via the Internet;
communicating with a first legacy application via the server to receive publication information, the first application configured to operating in accordance with a first operating system and to transmit the publishing information;
communicating with a second legacy application via the server to receive subscription information, the second legacy application configured to operating in accordance with a second operating system and to transmit the subscription information;
storing the publication information and the subscription information within a look-up table;
providing publication information from the first legacy application to the second legacy application based on the subscription information within the look-up table.

20. The method of claim 19 further comprising:
caching data from the first application within the server; and
transmitting the cached data from the server to the second application.
